(19) United States
(12) Patent Application Publication
(10) Pub. No.: US 2002/0126150 A1
(43) Pub. Date: Sep. 12, 2002

(54) Wireless updateable digital picture frame

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/802,039

(22) Filed: Mar. 7, 2001

(51) Int. Cl. G09G 5/00

(52) U.S. Cl. 345/771

(57) ABSTRACT

A wireless updateable digital picture frame includes a display, a memory, and a wireless component to receive digital images from an external device via wireless transfers. The wirelessly received images are stored in the memory and displayed on the display of the picture frame. Images may also optionally be wirelessly transferred to other devices external to the picture frame.

### TECHNICAL FIELD

This invention relates to digital imaging, and more particularly to digital picture frames.

### BACKGROUND

Digital cameras are becoming increasingly popular, expanding their market share at the expense of traditional film cameras. One beneficial feature of digital cameras is that all images are stored by the camera in a digital format, so no film needs to be developed and no hard copies of the images need to be printed by the developer. However, this feature can also be a problem because the user does not have ready access to hard copies of his or her pictures, unless he or she invests in a color printer capable of printing photographs, or sends his or her pictures to a developer for printing.

Not having a hard copy of photographs can be problematic for many users and intended viewers of the photographs. Users often pass photographs to one another in order to share their pictures. Unfortunately, without a hard copy of the photograph, this requires each user that wants to view the pictures to have a computer. Many people, however, either do not have a computer or have difficulty operating the computer they do have, making it difficult for them to view the digital images. Additionally, people typically do not have a computer sitting on their bookshelf, mantle, coffee table, refrigerator, or other places that they would typically put a hard copy of a photograph.

One solution to this problem is the use of a digital picture frame, however, current digital picture frames suffer from many problems. One current type of digital picture frame receives digital images from the Internet. The digital picture frame includes a modem and telephone jack that allows the frame to dial an access number to access the Internet, and then download the appropriate photographs once connected to the Internet. These types of digital picture frames have numerous problems. For example, they need to be connected to a telephone jack which either limits the places in which a user can put the frames (i.e., in close proximity to a telephone jack) or requires the user to move the frame close to a telephone jack each time he or she wants to put a new picture in the frame. Additionally, new pictures can be added to these frames only by downloading the pictures from the Internet. If the user's telephone line is not operational (or he or she does not have a telephone line), or if the user does not have a useable Internet access account, he or she will not be able to download a new picture into the frame.

Another type of digital picture frame receives its pictures from conventional CompactFlash™ or SmartMedia™ memory cards (the types of memory cards used by some current digital cameras to store images captured by the camera). An image captured by a digital camera to such a memory or media card is added to the digital picture frame by inserting the card into a card slot on the picture frame. Although these types of picture frames overcome the problems of requiring an Internet connection discussed above, they suffer from other problems. For example, not all manufacturers use the CompactFlash™ or SmartMedia™ memory cards. Rather, some manufacturers use other memory cards that are not compatible with CompactFlash™ or SmartMedia™ memory cards, and thus could not be inserted into these types of picture frames. Additionally, in order to transfer digitally captured images to such a digital picture frame, the memory or media card must be removed from the digital camera, thereby preventing any other pictures from being stored to that card until it is replaced (thus potentially resulting in picture-taking opportunities being lost). Furthermore, as the images that are displayed on such a digital picture frame are displayed from the memory card, in order for the same picture to be displayed on multiple such digital picture frames, multiple memory cards must be used (each storing the image to be displayed and each inserted into one of the multiple frames). Requiring such multiple memory cards is both expensive and inconvenient for the user. In addition, many digital cameras (especially lower-priced models) do not have any sort of a removable memory card. Rather, images are simply transferred via cable (e.g., a USB connection) from the camera to a computer. When using such cameras, it is a very time consuming process to load an image into the digital picture frame (e.g., requiring the user to go to his or her computer (which must have a device capable of writing to a CompactFlash™ or SmartMedia™ memory card), wait for the computer to power-on if not already running, download the image from the camera to the computer, locate an available CompactFlash™ or SmartMedia™ memory card, copy the image from the computer to the memory card, remove the memory card from the computer, and then move the memory card to the digital picture frame and insert it therein).

The invention described below addresses these disadvantages, providing a wireless updateable digital picture frame.

### SUMMARY

A wireless updateable digital picture frame is described herein.

According to one aspect, the digital picture frame includes a display, a memory, and a wireless component to receive digital images from an external device via wireless transfers. The wirelessly received images are stored in the memory and displayed on the display of the picture frame.

According to another aspect, the digital picture frame receives a request for a new digital image from an external wireless device (for example, a digital camera). The external wireless device sends a wireless communication to the digital picture frame informing the picture frame that a new digital image is about to be transferred to the picture frame, and then wirelessly sends the new digital image to the picture frame.

According to another aspect, the digital picture frame includes a wireless component to transmit digital images to an external device (e.g., a PDA, another digital picture frame, etc.) via wireless communications.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 illustrates an exemplary environment in which the invention can be practiced.

FIG. 2 is a block diagram illustrating an exemplary wireless digital picture frame in accordance with certain embodiments of the invention.

FIG. 3 is a flowchart illustrating an exemplary process for updating images on a wireless updateable digital picture frame in accordance with certain embodiments of the invention.

FIG. 4 is a flowchart illustrating an exemplary process for transferring images from a wireless updateable digital picture frame in accordance with certain embodiments of the invention.

### DETAILED DESCRIPTION

A wireless updateable digital picture frame is described herein. It should be noted that the use of “wireless” herein refers to the manner in which the digital picture frame is updated (that is, the manner in which new digital images are transferred to the picture frame). One or more other wires may still be coupled to the wireless updateable digital picture frame (e.g., a power cord).

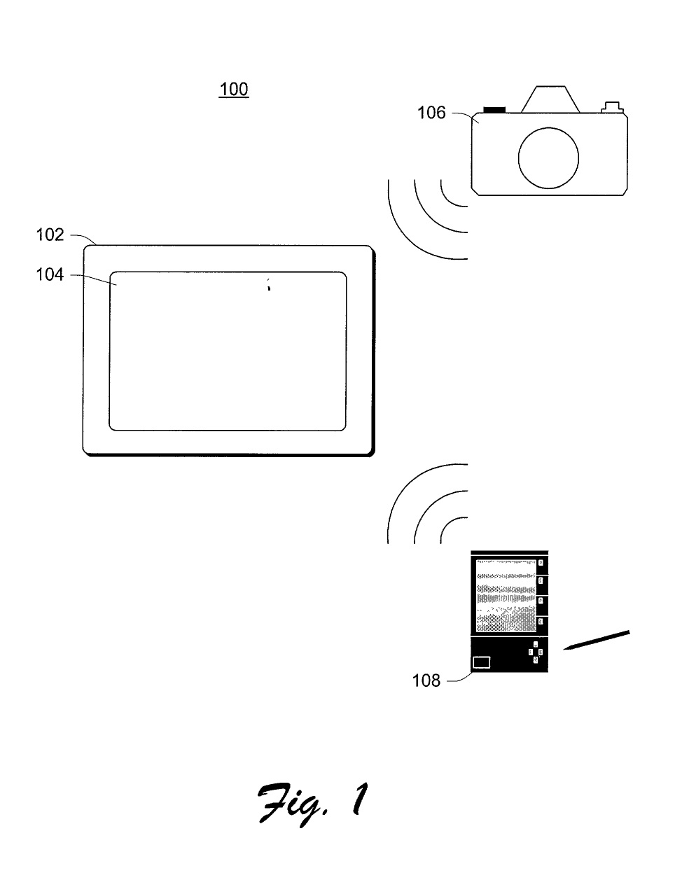

FIG. 1 illustrates an exemplary environment 100 in which the invention can be practiced. A wireless updateable digital picture frame 102 is illustrated having a display area 104. The display area is the portion of frame 102 in which digital images or pictures are displayed by frame 102. Two different image capture or storage devices, both external to frame 102, are illustrated: a digital camera 106 and a personal digital assistant (PDA) 108. Digital camera 106 operates in a conventional manner to capture images digitally and store the captured images internally in memory of camera 106. PDA 108 represents any of a wide variety of computing devices including dedicated PDAs, general purpose handheld or pocket personal computers, other personal computers, and so forth. Digital images can be captured by PDA 108 in a manner analogous to the operation of camera 106, or alternatively images may be transferred to PDA 108 from some other device (e.g., from a desktop computer).

A digital image or picture can be transferred from either camera 106 or PDA 108 to frame 102 and displayed in display area 104. This transfer is a wireless transfer, requiring no physical connection between the frame 102 and either camera 106 or PDA 108. Rather, the user simply situates the camera or PDA 108 in close physical proximity to frame 102 (the exact distance can vary, depending on the wireless protocol used as discussed in more detail below), and activates the image transfer function (e.g., by pushing a button or selecting the proper option on camera 106 or PDA 108).

The following example illustrates the use of, as well as some of the benefits of, wireless updateable digital picture frame 102. Assume that a child's birthday is being celebrated and that the whole family (parents, brothers, sisters, grandparents, aunts, uncles, cousins, and so forth) is in attendance. The child's father can take a picture of the child blowing out the candles on his or her cake, and then immediately activate the image transfer function to wirelessly communicate the captured image to a nearby picture frame 102 for the whole family to see. The captured image of the child blowing out the candles can thus be displayed on the picture frame 102 before the cake is even cut. Furthermore, if the picture frame is close enough to the father, the father may not even need to move in order to update the picture frame 102 with the recently captured picture, thus staying close by the action to capture more images.

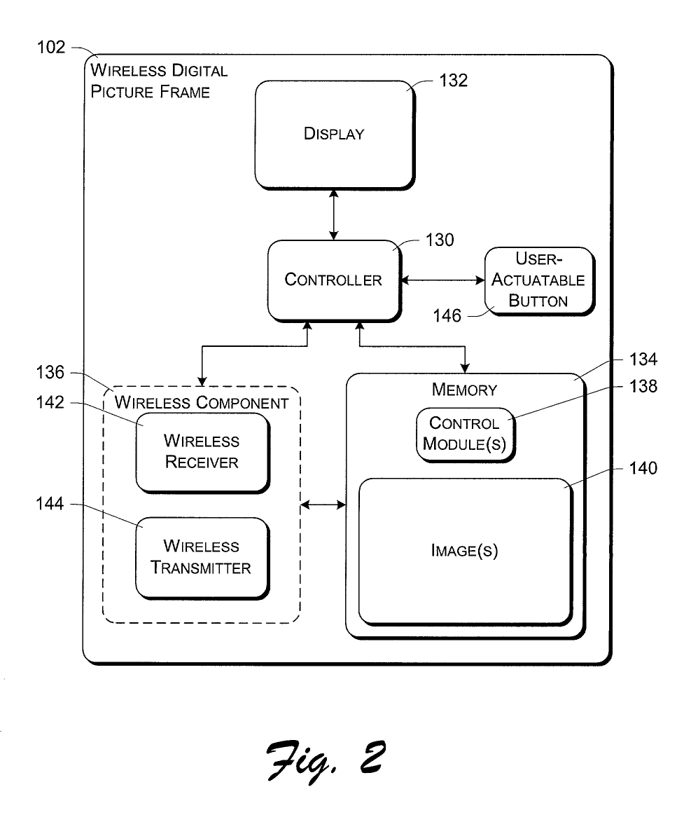

FIG. 2 is a block diagram illustrating an exemplary wireless digital picture frame 102 in accordance with certain embodiments of the invention. Picture frame 102 includes a controller 130, a display component 132, a memory 134, and a wireless component 136. Although illustrated as a direct coupling between controller 130 and each of the components 132 and 136 and memory 134, picture frame 102 can alternatively be architected in different manners (e.g., by coupling each of controller 130, components 132 and 136, and memory 134 to a common bus).

Wireless digital picture frame 102 is a device dedicated to displaying digital images or pictures. Although picture frame 102 includes a controller and memory, picture frame 102 is not designed to be a general-purpose processing device—rather, picture frame 102 is designed to predominantly perform operations used in displaying digital images (e.g., operations related to wirelessly receiving digital images, wirelessly transmitting digital images, displaying digital images, managing storage of digital images, and so forth).

Controller 130 manages the interaction of the various components and memory in picture frame 102. Controller 130 can be any of a wide variety of conventional controllers, such as a micro controller, microprocessor, application specific integrated circuit (ASIC), programmable logic device (PLD), etc. Controller 130 manages the display of an image(s) in memory 134 on display 132, and optionally manages the storage of received images into memory 134.

Display component 132 represents any of a wide variety of conventional display devices. Display component 132 may be an active matrix or passive matrix liquid crystal display (LCD), cathode ray tube (CRT) monitor, projector, or any other device capable of displaying images.

Memory 134 includes one or more control modules 138 and zero or more images 140. Memory 134 represents any of a wide variety of conventional memories, including volatile memory (e.g., RAM) and/or nonvolatile memory (e.g., Flash memory, EEPROMs, ROMs, optical or magnetic disk drives, etc.). Picture frame 102 may optionally be capable of storing multiple different digital images and allowing the user to select which one to be displayed, automatically changing which image is being displayed, and/or displaying multiple images concurrently. These are stored in memory 134 as images 140.

Control module(s) 138 are one or more control modules including instructions executed by controller 130 in order to perform its management capabilities. During operation, instructions are loaded from control module(s) 138 into controller 130, which in turn executes the instructions. Alternatively, controller 130 may be implemented as an ASIC or PLD which is configured to perform its management functions without executing instructions (in which case control module(s) 138 need not be included in memory 134).

Wireless component 136 includes a wireless receiver 142 and optionally a wireless transmitter 144. Depending on the wireless protocol being used, the wireless communications between frame 102 and camera 106 or PDA 108 of FIG. 1 may be bi-directional, in which case wireless transmitter 144 is used to wirelessly communicate information from frame 102 to camera 106 or PDA 108. Alternatively, the wireless communications between frame 102 and camera 106 or PDA 108 of FIG. 1 may be unidirectional, in which case wireless transmitter 144 need not be included in frame 102.

Wireless component 136 can be implemented in any of a wide variety of conventional manners. In one implementation, wireless component 136 is a wireless component designed specifically for use in frame 102 (e.g., one or more ASICs). Alternatively, wireless component 136 may be a general purpose wireless component (e.g., a wireless PCMCIA (Personal Computer Memory Card International Association) card that plugs into a PCMCIA slot of frame 102).

When an image is to be received at frame 102, controller 130 determines the location in memory 134 where the image is to be stored and communicates this location information to wireless component 136. Wireless component 136 then stores the received image data directly to that location(s) in memory 134. Alternatively, the received image data may be passed from wireless component 136 to controller 130, which in turn writes the received image data into the appropriate locations in memory 134. Images can be stored in memory 134 in any of a wide variety of formats, including both public and proprietary formats. For example, images may be stored in a JPEG (Joint Photographic Experts Group) format, a TIFF (Tagged Image File Format) format, a bitmap format, and so forth.

Wireless component 136 can operate based on any of a variety of conventional wireless technologies (e.g., infrared (IR), radio frequency (RF), etc.), and can conform to any one or more of a wide variety of communications protocols including both public and proprietary protocols. Examples of such communications protocols, including both current and proposed standards, are: Bluetooth (Bluetooth Specification version 1.0b, available from the Bluetooth Special Interest Group (SIG)), IEEE 802.11 (e.g., 802.11a or 802.11b, available from the Institute for Electrical and Electronics Engineers Inc. (IEEE) of Washington, D.C.), Wireless Access Protocol (WAP), version 1.2.1 (available from the WAP Forum), the HomeRF Shared Wireless Access Protocol (SWAP) version 2.0 (available form the HomeRF Working Group inc. of Portland, Oreg.), and so forth.

In order to communicate a new image from a camera 106 or PDA 108 of FIG. 1 to picture frame 102, the camera 106 or PDA 108 needs to know what image (if it stores multiple images) to transfer and picture frame 102 needs to know to receive the image. In one implementation, camera 106 or PDA 108 includes a user interface that allows the user to select one of the images stored thereon for transfer. This interface can be manually-actuatable buttons, a touchscreen, a graphical user interface (GUI), etc. To initiate transfer, the user selects a “transfer” option on either picture frame 102 or camera 106 (or PDA 108). For example, camera 106 may have a button or other user-selectable option that causes it to begin transferring the selected image to picture frame 102. Alternatively, picture frame 102 may have a button 146 or other user-selectable option that causes it to communicate a “begin image transfer” command to the camera 106 or PDA 108, causing the camera 106 or PDA 108 to begin transfer of the selected image.

According to another alternative, camera 106 or PDA 108 may wirelessly communicate a list of image identifiers to picture frame 102. The image identifiers (e.g., text descriptions, graphical thumbnails, etc.) are then displayed to the user, who in turn can select one of the displayed identifiers. This selection is then wirelessly communicated to the camera 106 or PDA 108, which wirelessly transmits the selected image to picture frame 102.

Regardless of the manner in which the digital image transfer from the source to picture frame 102 is initiated, the transfer remains a wireless transfer. Thus, nothing need be physically removed from the source (e.g., no memory cards), thereby freeing up the source to capture additional images.

In one implementation, situations can exist where multiple wireless devices (e.g., cameras 106 and PDAs 108) are within communications range of frame 102 (that is, in close enough proximity to picture frame 102 to wirelessly transfer images to picture frame 102). In this situation, the wireless communication protocol being used supports an address or other identification scheme that allows each of the wireless devices to be uniquely identified to the other devices. Additionally, if the “begin transfer” option is selected from frame 102, then frame 102 may optionally include a device selection option that allows the user to select one of the multiple devices from which to receive the image. The device selection option can be implemented with a mechanical actuation mechanism (e.g., a physical knob that rotates to multiple different settings) or alternatively as a graphical user interface (GUI) displayed on display 132.

In addition to receiving digital images via a wireless communications, picture frame 102 may also communicate images to other external devices via wireless component 136. Digital images can be communicated to any other device within the wireless communications range of picture frame 102, such as PDA 108 of FIG. 1, another picture frame 102, and so forth. In order to transmit a digital image from picture frame 102, an image stored in memory 134 is selected by the user (analogous to selection of an image to be transferred to picture frame 102 as discussed above), and then the image transfer is initiated (analogous to initiating transfer of an image to picture frame 102 as discussed above).

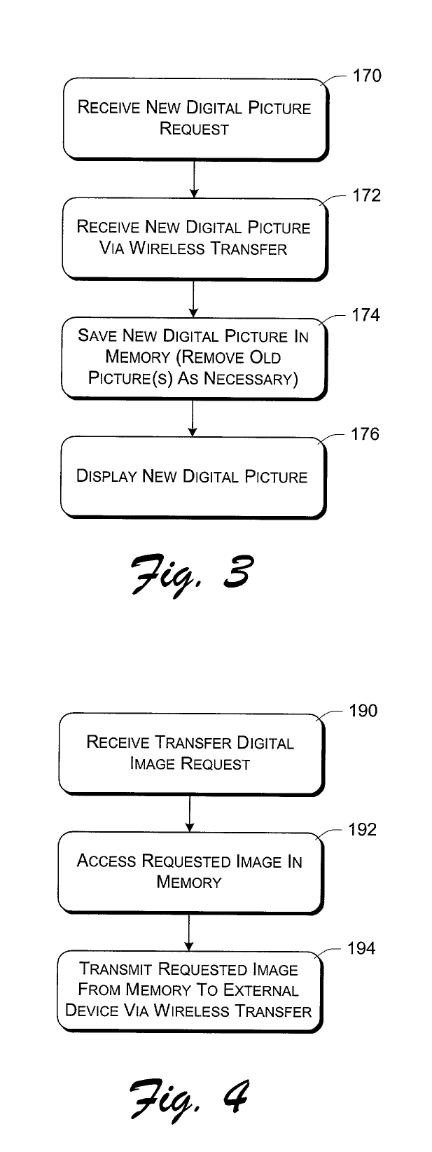

FIG. 3 is a flowchart illustrating an exemplary process for updating images on a wireless updateable digital picture frame in accordance with certain embodiments of the invention. The process of FIG. 3 is performed by controller 130 and/or wireless component 136 of FIG. 2, and may optionally be implemented in software.

Initially, a new digital picture request is received at a picture frame (act 170), such as picture frame 102 of FIG. 2. The new digital picture request can be received from a user input to the picture frame, or alternatively as a wireless communication from a digital image storage device (e.g., camera 106 or PDA 108 of FIG. 1). The new digital picture is then received at the picture frame via a wireless transfer (act 172), and stored in memory of the picture frame (act 174). Additionally, if storage space is needed in the memory of picture frame, then that space is cleared for use by the new image. Note that this memory space may be cleared prior to loading the new image into the memory, or alternatively may be inherently cleared by being overwritten by the new image. Once stored in memory, the newly received digital picture can be displayed (act 176).

FIG. 4 is a flowchart illustrating an exemplary process for transferring images from a wireless updateable digital picture frame in accordance with certain embodiments of the invention. The process of FIG. 3 is performed by controller 130 and/or wireless component 136 of FIG. 2, and may optionally be implemented in software.

Initially, a new digital picture request is received at the picture frame (act 190), such as picture frame 102 of FIG. 2. The new digital picture request can be received from a user input to the picture frame, or alternatively as a wireless communication from a digital image storage device (e.g., camera 106 or PDA 108 of FIG. 1), such as the device that will be receiving the image to be transferred. The image requested for transfer is then accessed in memory (act 192) and transmitted to the external device (e.g., PDA 108 of FIG. 1) via a wireless transfer (act 194).

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A digital picture frame comprising:
a wireless component configured to receive, from a source, a digital image via a wireless transfer;
a memory, coupled to the wireless component, to store the received digital image; and
a display device, coupled to the memory, to display the stored digital image.

2. A digital picture frame as recited in claim 1, further comprising a controller, coupled to the memory, configured to identify which of a plurality of images stored in the memory are to be displayed on the display device.

3. A digital picture frame as recited in claim 1, further comprising a controller, coupled to both the wireless component and the display device, configured to present on the display device a plurality of wireless devices that are currently within communications range of the digital picture frame.

4. A digital picture frame as recited in claim 3, wherein the controller is further configured to allow a user to select one of the plurality of wireless devices from which the digital image is to be received.

5. A digital picture frame as recited in claim 1, further comprising a user-actuatable mechanism, coupled to the wireless component, and wherein actuation of the user-actuatable mechanism initiates a transfer of a new digital image to the digital picture frame.

6. A digital picture frame as recited in claim 1, further comprising a controller, coupled to the wireless component, configured to receive a new digital image request from a wireless device external to the digital picture frame, and to manage reception of the new digital image from the wireless device.

7. A digital picture frame as recited in claim 1, wherein the source comprises a digital camera.

8. A digital picture frame as recited in claim 1, wherein the source comprises a personal digital assistant.

9. A digital picture frame as recited in claim 1, wherein the wireless component comprises a wireless receiver.

10. A digital picture frame as recited in claim 1, wherein the wireless component comprises both a wireless receiver and a wireless transmitter.

11. A digital picture frame as recited in claim 1, further comprising a controller, coupled to the memory, configured to manage storage and retrieval of a plurality of digital images in the memory.

12. A digital picture frame as recited in claim 11, wherein the controller is further configured to manage storage and retrieval of the plurality of digital images by executing one or more control modules stored in the memory.

13. A digital picture frame as recited in claim 1, wherein the wireless component is further configured to transmit the digital image stored in the memory to another source external to the digital picture frame.

14. A method implemented in a digital picture frame, the method comprising:
receiving a request for a new digital picture;
receiving the new digital picture via a wireless transfer; and
saving the new digital picture in a memory of the digital picture frame.

15. A method as recited in claim 14, further comprising:
receiving a request to transfer the new digital picture from the memory; and
transmitting the new digital picture to an external device via a wireless transfer.

16. A method as recited in claim 14, wherein receiving the new digital picture comprises receiving the new digital picture via a wireless transfer from a digital image source external to the digital picture frame.

17. A method as recited in claim 16, wherein the digital image source comprises a digital camera.

18. A method as recited in claim 14, further comprising displaying the new digital picture on a display of the digital picture frame.

19. A method as recited in claim 14, further comprising:
displaying a plurality of wireless devices that are within a wireless communications range of the digital picture frame; and
allowing the user to select one of the plurality of wireless devices from which the new digital picture is to be received.

20. A method as recited in claim 14, wherein receiving the request comprises receiving a request for a new digital picture from a digital image source external to the digital picture frame.

21. A method as recited in claim 20, wherein the digital image source comprises a digital camera.

22. A wireless updateable digital picture frame.

23. A picture frame as recited in claim 22, further comprising a removable wireless component, wherein the removable wireless component is configured to receive a digital image from an external image source via a wireless communication.

24. A picture frame as recited in claim 23, wherein the removable wireless component comprises a PCMCIA card.

25. One or more computer readable media having stored thereon a plurality of instructions that, when executed by a controller of a digital picture frame, causes the controller to perform acts including:
receiving a request for a new digital picture; and
managing reception of the new digital picture from a digital picture source via a wireless transfer.

26. One or more computer readable media as recited in claim 25, wherein managing reception of the new digital picture comprises managing reception of the new digital picture from a digital camera via a wireless transfer.

27. One or more computer readable media as recited in claim 25, wherein the plurality of instructions further causes the controller to perform acts including receiving the request for a new digital picture from a digital camera via a wireless connection.

28. One or more computer readable media as recited in claim 25, wherein the plurality of instructions further causes the controller to perform acts including transmitting, to a device external to the digital picture frame, the new digital picture via a wireless transfer.

29. A digital picture frame comprising:
means for displaying a digital image; and
means, coupled to the means for displaying, for receiving the digital image from an external source via a wireless communication.

30. A digital picture frame as recited in claim 29, wherein the external source comprises a digital camera.

31. A digital picture frame as recited in claim 30, wherein the means for receiving further comprises means for receiving a request for the digital image from the digital camera.
